(19) United States
(12) Patent Application Publication
(10) Pub. No.: US 2021/0017674 A1
(43) Pub. Date: Jan. 21, 2021

(54) CARBON NANOFIBER ADHESIVE FILM

(71) Applicant: Lintec Of America, Inc., Richardson, TX (US)

(72) Inventors: Emmanuel Aykara, Richardson, TX (US); Nicklas Keller, Richardson, TX (US)

(73) Assignee: Lintec Of America, Inc., Richardson, TX (US)

(21) Appl. No.: 16/929,505

(22) Filed: Jul. 15, 2020

Related U.S. Application Data
(60) Provisional application No. 62/876,032, filed on Jul. 19, 2019.

(51) Int. Cl. D01F 9/12; C08K 7/02; C01G 31/00; C01G 41/00; C01G 23/00; D02G 3/02; B32B 27/12; B32B 9/00; B32B 5/12; C01B 32/168

(52) U.S. Cl. CPC D01F 9/12; C08K 7/02; C01G 31/00; C01G 41/00; C01G 23/00; B82Y 30/00; B32B 27/12; B32B 9/007; B32B 5/12; C01B 32/168; D02G 3/02

(57) ABSTRACT

A filtered nanofiber film can be used as an intervening layer between the nanofiber structure (e.g., a drawn nanofiber sheet and/or a nanofiber forest) and a final substrate. Filtered nanofiber films can adhere to other types of nanofiber structures (e.g., drawn nanofiber sheets and/or nanofiber forests) and also exhibit adhesion to non-nanofiber surfaces. Thus, when used as an intervening layer between another type of nanofiber structure and a final substrate, a filtered film can increase adhesion therebetween. Filtered nanofiber films can also be used as a releasable protective film to prevent contamination of a confronting major surface of the nanofiber structure.

### RELATED APPLICATIONS

This application claims benefit under 35 U.S.C. § 119(e) to U.S. Provisional Application Ser. No. 62/876,032, titled “CARBON NANOFIBER ADHESIVE FILM,” filed on Jul. 19, 2019.

### TECHNICAL FIELD

The present disclosure relates generally to carbon nanofibers. Specifically, the present disclosure relates to carbon nanofiber adhesive films.

### BACKGROUND

Nanofibers are known to have unusual mechanical, optical, thermal, and electronic properties. Devising configurations of nanofibers that can be integrated into commercial products has been challenging because of the nanoscale dimensions of the nanofibers. PCT Publication No. WO 2007/015710 is one example of an advancement in developing commercially useful embodiments of nanofibers. This publication describes converting a nanofiber “forest” into a nanofiber sheet and/or yarn. The nanofiber sheets and yarns may then be applied in a variety of contexts.

### SUMMARY

Example 1 is a method comprising: providing a nanofiber structure having an exposed major surface, the nanofiber structure comprising an array of aligned nanofibers; providing a filtered nanofiber film having a first major surface and a second major surface; placing the first major surface of the filtered nanofiber film in contact with the exposed major surface of the nanofiber structure; placing the second major surface of the filtered nanofiber film in contact with a final substrate; and responsive to placing the second major surface of the filtered nanofiber film in contact with the final substrate, adhering the nanofiber structure to the final substrate via the filtered nanofiber film.

Example 2 includes the subject matter of Example 1, wherein the array of aligned nanofibers comprises a nanofiber forest or a drawn nanofiber sheet.

Example 3 includes the subject matter of Example 2, further comprising densifying the drawn nanofiber sheet by exposing the drawn nanofiber sheet to a solvent vapor or solvent steam.

Example 4 includes the subject matter of any of the preceding Examples, further comprising removing a releasable assembly from the second major surface of the filtered nanofiber film prior to placing the second major surface of the filtered nanofiber film on the final substrate.

Example 5 includes the subject matter of Example 4, wherein the releasable assembly comprises a support film and a nanofiber film coated on at least one surface with a material comprising a carbide-forming metal, the coated surface configured for contact with the second major surface of the filtered nanofiber film.

Example 6 includes the subject matter of any of the preceding Examples, further comprising exposing the filtered nanofiber film in contact with the final substrate to one or both of a steam or a vapor of a solvent, the exposing increasing adhesion between the filtered nanofiber film and the final substrate relative to the adhesion prior to the exposing.

Example 7 includes the subject matter of any of the preceding Examples, wherein the filtered nanofiber film comprises a plurality of nanofibers randomly oriented relative to one another in a plane of the filtered nanofiber film.

Example 8 includes the subject matter of any of the preceding Examples, wherein the adhesion between the nanofiber structure and the final substrate via the filtered nanofiber film is greater than adhesion from direct contact between the nanofiber structure and the final substrate.

Example 9 is a nanofiber assembly comprising: a first assembly comprising: a first film comprising a first polymer; a first nanofiber film comprising a first plurality of nanofibers randomly oriented relative to one another in a plane of the first nanofiber film, the first nanofiber film having a first major surface and a second major surface; a nanofiber structure comprising an array of aligned nanofibers between the first film and the first nanofiber film, the nanofiber structure in contact with the first major surface of the first film; a second assembly comprising: a second nanofiber film on the second film, the second nanofiber film comprising a second plurality of nanofibers randomly oriented relative to one another in a plane of the second nanofiber film; and a coating on at least one major surface of the second nanofiber film, the coating in releasable contact with the second major surface of the first nanofiber film.

Example 10 includes the subject matter of Example 9, wherein the array of aligned nanofibers comprises a nanofiber forest or a drawn nanofiber sheet.

Example 11 includes the subject matter of either one of Examples 9 or 10, wherein the coating comprises a carbide-forming metal.

Example 12 includes the subject matter of Example 11, wherein the carbide-forming metal includes vanadium, tungsten, titanium, and alloys thereof.

Example 13 includes the subject matter of any of Examples 9 to 12, wherein the second assembly is removable from the first assembly without damaging the first assembly.

Example 14 is an assembly comprising: a nanofiber structure comprising an array of aligned nanofibers; a substrate under the nanofiber structure; and a nanofiber film between the nanofiber structure and the substrate, the nanofiber film comprising a plurality of nanofibers randomly oriented relative to one another in a plane of the nanofiber film, the nanofiber film having a first major surface and a second major surface, wherein the first major surface of the nanofiber film is in direct contact with a confronting surface of the nanofiber structure and the second major surface of the nanofiber film is in direct contact with a confronting surface of the substrate.

Example 15 includes the subject matter of Example 14, wherein the nanofiber structure of aligned nanofibers comprises a nanofiber forest or a drawn nanofiber sheet.

Example 16 includes the subject matter of Example 15, wherein the drawn nanofiber sheet is a densified drawn nanofiber sheet.

Example 17 includes the subject matter of any of Examples 14 to 16, wherein the nanofiber film comprises 80 weight % or less of multiwall carbon nanotubes and 20 weight % or more of one or both of single wall or few wall carbon nanotubes, a total of which is 100 weight %.

Example 18 includes the subject matter of Example 17, wherein: the multiwall carbon nanotubes have from 4 to 20 concentric walls and a diameter of from 4 nm to 100 nm; the few wall carbon nanotubes have 2 or 3 concentric walls and a diameter of from 2 nm to 6 nm; and the single wall carbon nanotubes have a diameter of from 0.2 nm to 4 nm.

### BRIEF DESCRIPTION OF THE DRAWINGS

FIG. 1 is a photomicrograph of an example forest of nanofibers on a substrate, in an embodiment.

FIG. 2 is a schematic illustration of an example reactor for nanofiber growth, in an embodiment.

FIG. 3 is an illustration of a nanofiber sheet that identifies relative dimensions of the sheet and schematically illustrates nanofibers within the sheet aligned end-to-end in a plane parallel to a surface of the sheet, in an embodiment.

FIG. 4 is an SEM photomicrograph is an image of a nanofiber sheet being laterally drawn from a nanofiber forest, the nanofibers aligning from end-to-end as schematically, in an embodiment.

FIG. 5 is a schematic illustration of a portion of a filtered nanofiber film that includes larger and longer multiwall carbon nanofibers intermixed with single wall and/or few wall carbon nanofibers, all of which are randomly oriented within a plane of the film, in an embodiment.

FIGS. 6A-6H illustrate an example method for mounting a filtered nanofiber film to a nanofiber forest to improve adhesion of the forest to a final substrate, in an embodiment.

FIGS. 7A-7C illustrate an example method of adhering an assembly of a drawn nanofiber sheet and a filtered nanofiber film to final substrate, in an embodiment.

The figures depict various embodiments of the present disclosure for purposes of illustration only. Numerous variations, configurations, and other embodiments will be apparent from the following detailed discussion.

### DETAILED DESCRIPTION

### Overview

Carbon nanofibers can be formed into a number of technologically interesting configurations. Example configurations include a nanofiber “forest,” a nanofiber sheet, and a nanofiber film. A nanofiber forest has an array of nanofibers generally parallel to one another and at an angle between 5° and 90° relative to a surface of a substrate, where first ends of the nanofibers are coplanar with one another and adjacent to the surface of the substrate. A nanofiber sheet can be drawn from a nanofiber forest so that the nanofibers are in an end-to-end configuration within the plane of the drawn sheet. A nanofiber film (sometimes referred to herein as a “filtered nanofiber film” or “filtered film”) can be formed by suspending nanofibers in a solvent and removing the solvent from the suspension to form a film of nanofibers that are randomly oriented within the plane of the film.

Each of these structures may have different optical, thermal, electrical and/or mechanical properties due to the different orientation of nanofibers relative to a substrate and/or relative to one another. In particular, in some cases a nanofiber forest may be difficult to adhere to an underlying substrate without using a separate, intervening adhesive layer. For example, nanofiber forests, once removed from the substrate on which they are formed (a “growth substrate”), can be difficult to adhere to a surface on which the unusual properties of the forest are desired. For illustration, nanofiber forests have very high thermal emissivity and very high absorption of wavelengths in the visible spectrum. The high thermal emissivity makes nanofiber forests an interesting coating for structures in which these properties are desired. Example applications include applying a nanofiber forest to structures in which thermal emissivity is a mechanism of cooling (e.g., in conditions in which conductive or convective cooling is low or not feasible). However, adhering a nanofiber forest to a surface using a conventional adhesive (e.g., organic compounds that include acrylate or methacrylate groups, epoxides, and others) can degrade the thermal emissivity (among other properties) of the forest. Not only will an intervening adhesive layer act as a thermal insulator, reducing the rate of heat transfer to the nanofiber forest, but the adhesive layer may also contaminate the nanofiber forest and thus may degrade the properties otherwise exhibited by an uncontaminated forest. Similar illustrations can be found for each of the different configurations of nanofiber structures.

Thus, in accordance with the following description, embodiments are presented in which a filtered nanofiber film can be used to improve adhesion between a final substrate and a nanofiber structure (e.g., a nanofiber forest and/or a drawn nanofiber sheet). Filtered nanofiber films can be used to improve adhesion between a nanofiber structure and a final substrate by at least two different mechanisms. First, a filtered nanofiber film can be processed so as to form a releasable connection with a major surface of a nanofiber structure. The filtered nanofiber film can protect the confronting major surface of the nanofiber structure from contamination, thus preserving an ability of a pristine surface of the nanofiber structure to be adhered to a final substrate. Second, a filtered nanofiber film can be used as an intervening layer between the nanofiber structure (e.g., a drawn nanofiber sheet and/or a nanofiber forest). Filtered nanofiber films can adhere to other types of nanofiber structures (e.g., drawn nanofiber sheets and/or nanofiber forests) and can also adhere (in some cases tightly and non-releasably) to non-nanofiber surfaces. Thus, when used as an intervening layer between another type of nanofiber structure and a final substrate, a filtered film can increase adhesion therebetween relative direct contact between the nanofiber forest/nanofiber sheet and the final substrate. Unlike organic adhesives, the filtered nanofiber film will not contaminate or degrade the properties of the other nanofiber structure.

Prior to describing these adhesion-improving embodiments, various nanofiber structures and example methods of synthesis will be described.

### Nanofiber Forests

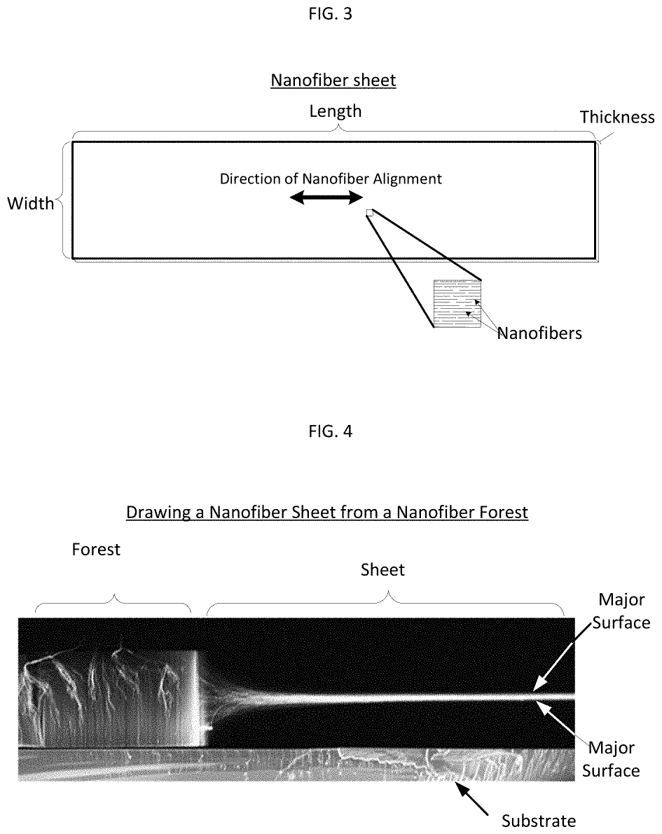

As used herein, the term “nanofiber” means a fiber having a diameter less than 1 μm. While the embodiments herein are primarily described as fabricated from carbon nanotubes, it will be appreciated that other carbon allotropes, whether graphene, micron or nano-scale graphite fibers and/or plates, and even other compositions of nano-scale fibers such as boron nitride may be encompassed using the techniques described below. As used herein, the terms “nanofiber” and “nanotube” encompass both single walled carbon nanotubes and/or multi-walled carbon nanotubes in which carbon atoms are linked together to form a cylindrical structure. In some embodiments, carbon nanotubes as referenced herein have between 4 and 10 walls. As used herein, a “nanofiber sheet” or simply “sheet” refers to a sheet of nanofibers aligned via a drawing process (as described in PCT Publication No. WO 2007/015710, and incorporated by reference herein in its entirety) so that a longitudinal axis of a nanofiber of the sheet is parallel to a major surface of the sheet, rather than perpendicular to the major surface of the sheet (i.e., in the as-deposited form of the sheet, shown in FIG. 2, often referred to as a “forest”). This is illustrated and shown in FIGS. 3 and 4, respectively.

The dimensions of carbon nanotubes can vary greatly depending on production methods used. For example, the diameter of a carbon nanotube may be from 0.4 nm to 100 nm and its length may range from 10 μm to greater than 55.5 cm. Carbon nanotubes are also capable of having very high aspect ratios (ratio of length to diameter) with some as high as 132,000,000:1 or more. Given the wide range of dimensional possibilities, the properties of carbon nanotubes are highly adjustable, or “tunable.” While many intriguing properties of carbon nanotubes have been identified, harnessing the properties of carbon nanotubes in practical applications requires scalable and controllable production methods that allow the features of the carbon nanotubes to be maintained or enhanced.

Due to their unique structure, carbon nanotubes possess particular mechanical, electrical, chemical, thermal and optical properties that make them well-suited for certain applications. In particular, carbon nanotubes exhibit superior electrical conductivity, high mechanical strength, good thermal stability and are also hydrophobic. In addition to these properties, carbon nanotubes may also exhibit useful optical properties. For example, carbon nanotubes may be used in light-emitting diodes (LEDs) and photo-detectors to emit or detect light at narrowly selected wavelengths. Carbon nanotubes may also prove useful for photon transport and/or phonon transport.

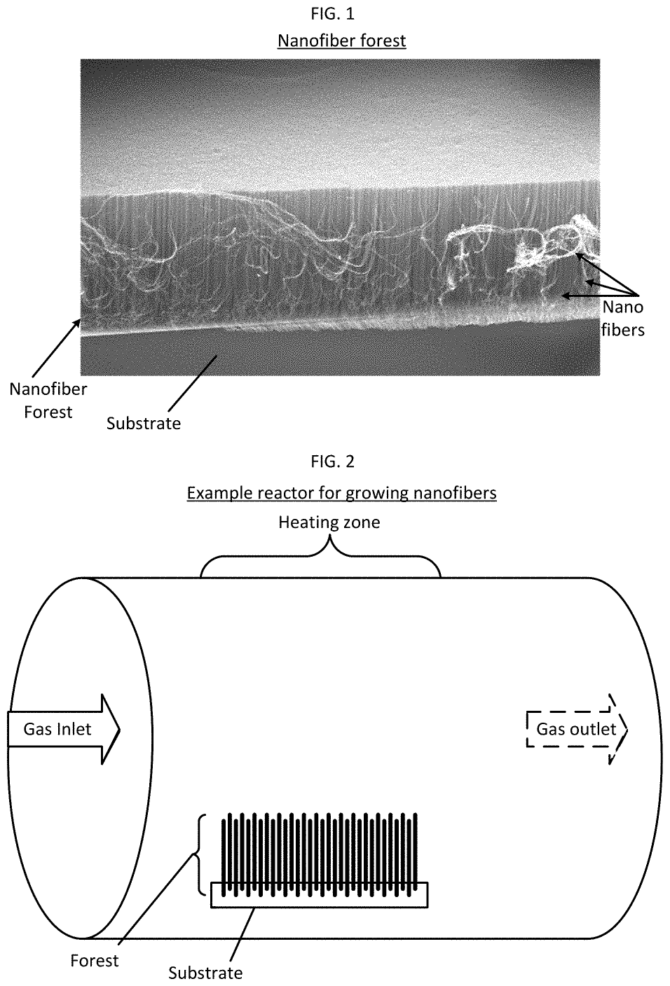

In accordance with various embodiments of the subject disclosure, nanofibers (including but not limited to carbon nanotubes) can be arranged in various configurations, including in a configuration referred to herein as a “forest.” As used herein, a “forest” of nanofibers or carbon nanotubes refers to an array of nanofibers having approximately equivalent dimensions that are arranged substantially parallel to one another on a substrate. FIG. 1 shows an example forest of nanofibers on a substrate. The substrate may be any shape but in some embodiments the substrate has a planar surface on which the forest is assembled. As can be seen in FIG. 1, the nanofibers in the forest may be approximately equal in height and/or diameter.

Nanofiber forests as disclosed herein may be relatively dense. Specifically, the disclosed nanofiber forests may have a density of at least 1 billion nanofibers/cm². In some specific embodiments, a nanofiber forest as described herein may have a density of between 10 billion/cm² and 30 billion/cm². In other examples, the nanofiber forest as described herein may have a density in the range of 90 billion nanofibers/cm². The forest may include areas of high density or low density and specific areas may be void of nanofibers. The nanofibers within a forest may also exhibit inter-fiber connectivity. For example, neighboring nanofibers within a nanofiber forest may be attracted to one another by van der Waals forces. Regardless, a density of nanofibers within a forest can be increased by applying techniques described herein.

Methods of fabricating a nanofiber forest are described in, for example, PCT No. WO2007/015710, which is incorporated herein by reference in its entirety.

Various methods can be used to produce nanofiber precursor forests. For example, in some embodiments nanofibers may be grown in a high-temperature furnace, schematically illustrated in FIG. 2. In some embodiments, catalyst may be deposited on a substrate, placed in a reactor and then may be exposed to a fuel compound that is supplied to the reactor. Substrates can withstand temperatures of greater than 800° C. or even 1000° C. and may be inert materials. The substrate may comprise stainless steel or aluminum disposed on an underlying silicon (Si) wafer, although other ceramic substrates may be used in place of the Si wafer (e.g., alumina, zirconia, SiO₂, glass ceramics). In examples where the nanofibers of the forest are carbon nanotubes, carbon-based compounds, such as acetylene may be used as fuel compounds. After being introduced to the reactor, the fuel compound(s) may then begin to accumulate on the catalyst and may assemble by growing upward from the substrate to form a forest of nanofibers. The reactor also may include a gas inlet where fuel compound(s) and carrier gasses may be supplied to the reactor and a gas outlet where expended fuel compounds and carrier gases may be released from the reactor. Examples of carrier gases include hydrogen, argon, and helium. These gases, in particular hydrogen, may also be introduced to the reactor to facilitate growth of the nanofiber forest. Additionally, dopants to be incorporated in the nanofibers may be added to the gas stream.

In a process used to fabricate a multilayered nanofiber forest, one nanofiber forest is formed on a substrate followed by the growth of a second nanofiber forest in contact with the first nanofiber forest. Multi-layered nanofiber forests can be formed by numerous suitable methods, such as by forming a first nanofiber forest on the substrate, depositing catalyst on the first nanofiber forest and then introducing additional fuel compound to the reactor to encourage growth of a second nanofiber forest from the catalyst positioned on the first nanofiber forest. Depending on the growth methodology applied, the type of catalyst, and the location of the catalyst, the second nanofiber layer may either grow on top of the first nanofiber layer or, after refreshing the catalyst, for example with hydrogen gas, grow directly on the substrate thus growing under the first nanofiber layer. Regardless, the second nanofiber forest can be aligned approximately end-to-end with the nanofibers of the first nanofiber forest although there is a readily detectable interface between the first and second forest. Multi-layered nanofiber forests may include any number of forests. For example, a multi-layered precursor forest may include two, three, four, five or more forests.

### Nanofiber Sheets

In addition to arrangement in a forest configuration, the nanofibers of the subject application may also be arranged in a sheet configuration. As used herein, the term “nanofiber sheet,” “nanotube sheet,” or simply “sheet” refers to an arrangement of nanofibers where the nanofibers are aligned end to end in a plane. An illustration of an example nanofiber sheet is shown in FIG. 3 with labels of the dimensions. In some embodiments, the sheet has a length and/or width that is more than 100 times greater than the thickness of the sheet. In some embodiments, the length, width or both, are more than 10³, 10⁶ or 10⁹ times greater than the average thickness of the sheet. A nanofiber sheet can have a thickness of, for example, between approximately 5 nm and 30 μm and any length and width that are suitable for the intended application. In some embodiments, a nanofiber sheet may have a length of between 1 cm and 10 meters and a width between 1 cm and 1 meter. These lengths are provided merely for illustration. The length and width of a nanofiber sheet are constrained by the configuration of the manufacturing equipment and not by the physical or chemical properties of any of the nanotubes, forest, or nanofiber sheet. For example, continuous processes can produce sheets of any length. These sheets can be wound onto a roll as they are produced.

As can be seen in FIG. 3, the axis in which the nanofibers are aligned end-to end is referred to as the direction of nanofiber alignment. In some embodiments, the direction of nanofiber alignment may be continuous throughout an entire nanofiber sheet. Nanofibers are not necessarily perfectly parallel to each other and it is understood that the direction of nanofiber alignment is an average or general measure of the direction of alignment of the nanofibers.

Nanofiber sheets may be assembled using any type of suitable process capable of producing the sheet. In some example embodiments, nanofiber sheets may be drawn from a nanofiber forest. An example of a nanofiber sheet being drawn from a nanofiber forest is shown in FIG. 4

As can be seen in FIG. 4, the nanofibers may be drawn laterally from the forest and then align end-to-end to form a nanofiber sheet. In embodiments where a nanofiber sheet is drawn from a nanofiber forest, the dimensions of the forest may be controlled to form a nanofiber sheet having particular dimensions. For example, the width of the nanofiber sheet may be approximately equal to the width of the nanofiber forest from which the sheet was drawn. Additionally, the length of the sheet can be controlled, for example, by concluding the draw process when the desired sheet length has been achieved.

Nanofiber sheets have many properties that can be exploited for various applications. For example, nanofiber sheets may have tunable opacity, high mechanical strength and flexibility, thermal and electrical conductivity, and may also exhibit hydrophobicity. Given the high degree of alignment of the nanofibers within a sheet, a nanofiber sheet may be extremely thin. In some examples, a nanofiber sheet is on the order of approximately 10 nm thick (as measured within normal measurement tolerances), rendering it nearly two-dimensional. In other examples, the thickness of a nanofiber sheet can be as high as hundreds of nanometers or tens of microns. As such, nanofiber sheets may add minimal additional thickness to a component.

As with nanofiber forests, the nanofibers in a nanofibers sheet may be functionalized by a treatment agent by adding chemical groups or elements to a surface of the nanofibers of the sheet and that provide a different chemical activity than the nanofibers alone. Functionalization of a nanofiber sheet can be performed on previously functionalized nanofibers or can be performed on previously unfunctionalized nanofibers. Functionalization can be performed using any of the techniques described herein including, but not limited to CVD, and various doping techniques.

Nanofiber sheets, as-drawn from a nanofiber forest, may also have high purity, wherein more than 90%, more than 95% or more than 99% of the weight percent of the nanofiber sheet is attributable to nanofibers, in some instances. Similarly, the nanofiber sheet may comprise more than 90%, more than 95%, more than 99% or more than 99.9% by weight of carbon.

In some examples, a nanofiber sheet drawn from a nanofiber forest can be “densified” by exposure to a solvent or solvent vapor. In some examples, the infiltration of solvent molecules into the interior of the drawn nanofiber sheet structure (i.e., into gaps between nanofibers within the drawn sheet), and subsequent removal can cause the individual nanofibers to be drawn closer to one another. This “densification” can be primarily in the thickness dimension of the nanofiber sheet, reducing the thickness by a factor of from 10 to 1000 (e.g., reducing the thickness from microns to nanometers). A width of a densified sheet can remain substantially unchanged from its pre-densified width, reducing less than 10%, less than 5% or less than 1% in response to exposure to a solvent. Examples of solvents that can be used for densifying a nanofiber sheet include, but are not limited to, protic solvents, aprotic solvents, polar solvents, non-polar solvents, and combinations thereof. Specific solvents include, but are not limited to, isopropanol (IPA), toluene, ethanol, methanol, tetrahydrofuran (THF), solutions thereof, and solutions of any one or more of the foregoing with water. In some cases, the solvent can be applied to the nanofiber sheet in a liquid phase to saturate the surface. In other cases, the solvent can be applied as a steam (e.g., by heating the solvent near the boiling point or to the boiling point) or as a vapor or aerosol (e.g., by producing micro or nanoscale droplets from ultrasonic agitation). In some examples, the solvent or solvent vapor can also be used as a vehicle to provide another material to a surface or interior of a nanofiber sheet. For example, a polymer (e.g., an adhesive, a thermoplastic, a thermoset) can be solvated in a solvent and then applied to a nanofiber sheet, as described above. In another example, colloidal particles or nanoparticles (e.g., silver nanoparticles, graphene nanoparticles) can be provided to a surface and/or an interior of a nanofiber sheet upon suspension in a solvent and application of the solvent to the nanofiber sheet. Once the solvent is removed from the sheet (e.g., by application of heat, vacuum, or both), the “infiltrated” substance remains.

### Filtered Nanofiber Films

A “nanofiber film” or “filtered nanofiber film” is another configuration of nanofiber structure. In some examples, nanofiber films can be formed from any combination of multiwalled carbon nanotubes, single walled carbon nanotubes, and few wall carbon nanotubes. This can be different from nanofiber forests and nanofiber sheets which, due to the nature of the processing described above in the context of FIG. 2, are primarily formed from one wall-type of carbon nanofiber (e.g., multi-wall nanofibers or single wall nanofibers, but not both). As such, filtered nanofiber films can be described as “composite films” due to the combination or mixture of different nanofiber wall types. Furthermore, nanofiber films are composed of nanofibers that are randomly oriented relative to one another within a plane of the film. This random orientation is a result of the process used to produce filtered films, as described below in the context of FIG. 5. In some examples, the relative weight proportion of one type of filtered film is a maximum of 80 weight (wt.) % multiwalled carbon nanotubes and a minimum of 20 wt. % single and/or few wall nanotubes. Lengths of the multiwalled carbon nanotubes can be controlled by lengthening or shortening the growth process in the chemical vapor deposition reactor, as described above. But for examples herein, a multiwalled carbon nanotube length can have a median length of approximately 300 μm (+/− 10%). As will be appreciated in light of the following description, multiwalled carbon nanotubes having a length of at least 250 μm or longer can be included in a filtered film to improve the mechanical stability of filtered films that also include single wall and/or few wall carbon nanotubes, which generally are shorter (e.g. from 0.5 μm to 30 μm).

FIG. 5 is a schematic illustration of a filtered nanotube film 500, in an example of the present disclosure. As shown, the composite nanotube filtered film 500 includes single/few wall nanotubes 504 that are inter-dispersed with multiwall carbon nanotubes 508. As described below, the filtered nanotube film 500 is formed by first fabricating the different types of nanotubes. The processes used to form multiwall carbon nanotubes (e.g., carbon nanotubes having from 4 to 20 concentric walls and a diameter of from 4 nm to 100 nm), few wall carbon nanotubes (e.g., carbon nanotubes having two or three concentric walls and a diameter of from 2 nm to 6 nm), and single wall carbon nanotubes (e.g., 1 wall and a tube diameter of from 0.2 nm to 4 nm) can differ from one another. For example, while multiwall carbon nanotubes can be fabricated using a chemical vapor deposition process on a relatively thick layer of catalyst (e.g., from 10 nm to several microns thick) on a substrate, few and single wall carbon nanofibers are often formed using laser ablation, carbon arc processes, or chemical vapor deposition (using e.g., acetylene, ethane as precursor) on a layer of catalyst that is thin (e.g., 0.2 nm to 10 nm thick) and which may be discontinuous across the substrate. Laser ablation generally produces shorter carbon nanotubes than those produced by chemical vapor deposition and may produce nanotubes with fewer crystallographic defects. For at least this reason, generally the processes used to produce one type of nanofiber do not produce measurable amounts of the other types of nanofibers. It will be appreciated that while some embodiments include nanotubes matching the above indicated number of walls and dimensions, it will be appreciated that the disclosure is not limited to these characterizations, which are presented for convenience of explanation.

In this example film 500, the single/few wall carbon nanotubes 508 can have at least two beneficial effects on the structure of the film 500 as a whole. For example, the single/few wall carbon nanotubes 504 can increase the number of indirect connections between proximate multiwalled carbon nanotubes 508 by bridging the gaps between them. These interconnections between the short and long nanofibers can improve the transfer and distribution of forces applied to the film and thus improve physical and mechanical durability. In a second example of a beneficial effect, the single/few wall carbon nanotubes 504 can decrease a median or mean size of the gaps between adjacent and/or overlapping multiwall carbon nanotubes 508. Furthermore, too many longer multiwalled carbon nanotubes can, when dispersed in a solvent, agglomerate. This can result in a non-uniform film. Shorter nanotubes are more easily dispersed in a solvent and thus are more likely to form a dimensionally uniform film having a uniform density of nanotubes per unit volume.

Filtered films, such as the film 500, can be fabricated in any of a variety of ways. For example, a dry mixture of the desired proportion of multiwalled carbon nanotubes and few/single walled carbon nanotubes can be mixed and then suspended in a solvent. In another example, separate suspensions of known concentrations are prepared of multiwalled carbon nanotubes and one or more of few wall carbon nanotubes and single wall nanotubes. The suspensions can then be mixed in proportions to arrive at the desired relative weights of the multiwall, and few/single wall nanotubes in the final filtered film.

When preparing the one or more suspensions, dry carbon nanotubes can be mixed with the solvent to uniformly distribute the nanotubes in the solvent as a suspension. Mixing can include mechanical mixing (e.g., using a magnetic stir bar and stirring plate), ultrasonic agitation (e.g., using an immersion ultrasonic probe) or other means. In some examples the solvent can be water, isopropyl alcohol (IPA), N-Methyl-2-pyrrolidone (NMP), dimethyl sulfide (DMS), and combinations thereof. In some examples a surfactant can also be included to aid the uniform dispersion of carbon nanofibers in the solvent. Example surfactants include, but are not limited to, sodium cholate, sodium dodecyl sulfate (SDS), and sodium dodecyl benzene sulphonate (SDBS). Weight percentage of surfactant in the solvent can be anywhere between 0.1 weight % to 10 wt. % of solvent. In one embodiment, a mixture of 50 wt. % multiwalled carbon nanotubes and 50 wt. % few/single wall carbon nanotubes can be prepared and suspended in water and SDS surfactant.

The solution can then be introduced into a structure that removes the solvent and causes the formation of a film of randomly oriented nanofibers on a substrate. Examples of this process include, but are not limited to, vacuum filtration onto a substrate of filter paper. Because this composite “filtered film” of nanotubes is hydrophobic, the filtered film can be separated from the filter paper (or other substrate) by immersing the substrate and film into water, thus causing the composite film to float on the surface of water. A frame can then be used to lift the film from the surface of the water, thus depositing the filtered film on the frame. If needed, the surface tension of the water (or other solvent) can be modified by adding surfactants or other solvents. The composite film can then be dried (e.g., using a low humidity environment, heat, vacuum). This process can be repeated to form different films of, optionally, differently composed mixtures of multiwall, few wall, and/or single wall nanotubes.

This example process can be repeated multiple times to produce multiple films of carbon nanotubes. In some examples, individual films (having the same or different proportions of multiwall and few/single walled carbon nanotubes in each film) are stacked on one another to form a multilayer composite film. Stacking two or more films can produce a more uniform stack with more uniform properties. For example, if one film in the stack has a local defect (e.g., a hole or tear), adjacent films in the stack can provide physical continuity and uniformity of the properties that would otherwise be absent at the location of the defect. In some embodiments, a stack can include anywhere from 2 to 10 individual films, each of which can have a same or different composition (that is, a different relative proportion of multiwall to single/few wall carbon nanotubes) from other films in the stack.

In some examples, a stacked film can be exposed to a densifying solvent that includes water, IPA, NMP, Dimethylformamide (DMF), toluene, or combinations thereof. Exposure to a densifying solvent can cause the films in a stack to adhere to one another. In some cases, not only do the films in the stack adhere to one another, but they merge so as to become indistinguishable from one another, even when using microscopy techniques to examine a cross-section of the stack. In other words, the densified stack does not have visible or microscopically detectable interfaces between layers.

### Filtered Nanofiber Films as Adhesion Layers

As indicated above, nanofiber forests and nanofiber sheets drawn from nanofiber forests may not readily adhere to a surface of a substrate absent an adhesive. Traditional adhesives (e.g., containing polymeric or oligomeric molecules, acrylate functional groups, diene functional groups) can, when present, degrade the otherwise desirable properties or performance characteristics of the nanofiber structures. To overcome this challenge, embodiments described below include an intervening filtered film used to adhere another nanofiber structure (e.g., a nanofiber forest or a nanofiber sheet) to a final substrate. Example final substrates can include plates, frames, and other surfaces formed from metals (e.g., aluminum, steel, iron, and corresponding alloys), ceramics (e.g., alumina, glass ceramics, zirconia, silicon dioxide), and plastics.

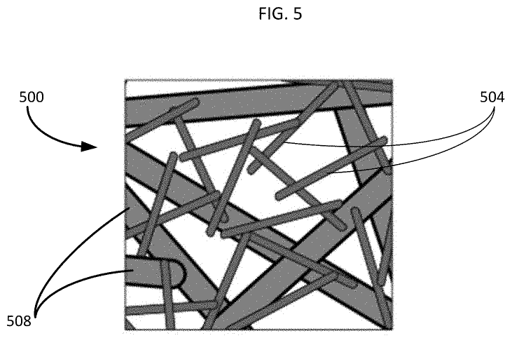

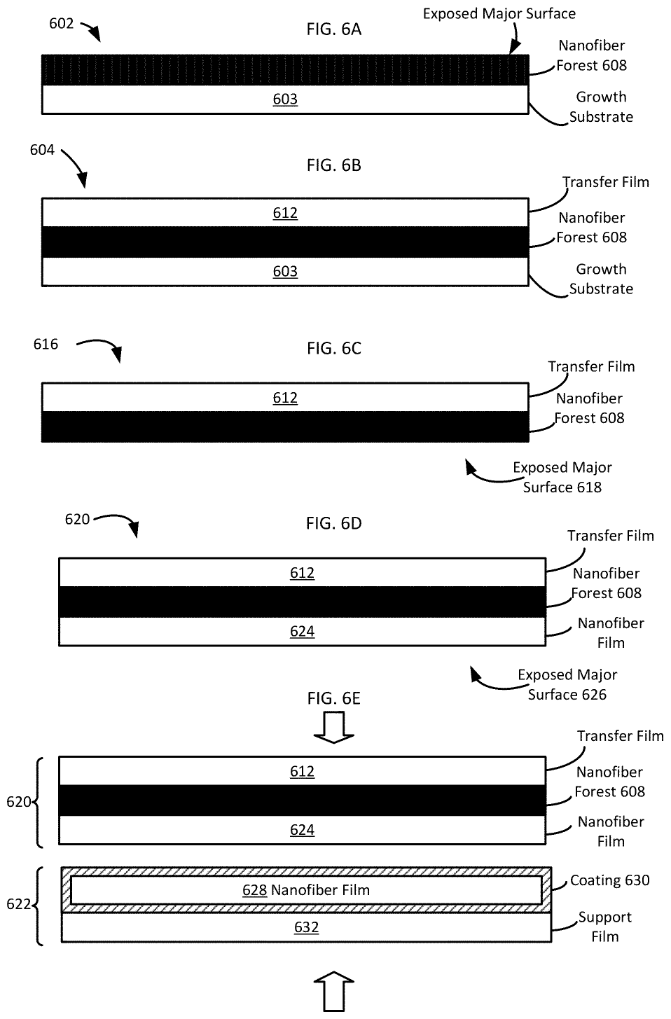

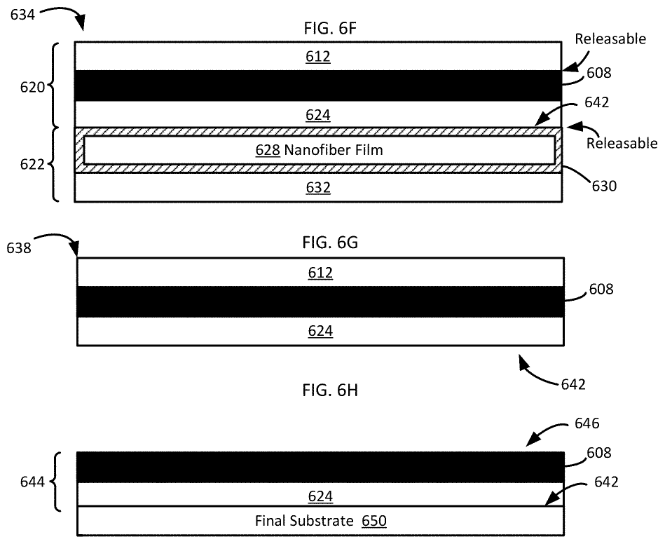

FIGS. 6A-6H illustrate stages of one example method of using a filtered nanofiber film to adhere other types of nanofiber structures to a final substrate surface. These figures also illustrate an optional process of preparing a nanofiber structure for transportation by mounting a filtered nanofiber film to a major surface of the nanofiber structure. In this example, the filtered nanofiber film includes a coating so as to establish a releasable connection to the major surface of the nanofiber structure. In this way, the removable filtered film can prevent contamination of the major surface.

A starting point of one example technique is presented in FIG. 6A, in which a first assembly 602 that includes a nanofiber forest 608 on a growth substrate 603 is provided. Nanofiber forests, their structure, and techniques of formation on a growth substrate are described above in the context of FIGS. 1 and 2.

FIG. 6B illustrates a second stack 604 in which a transfer film 612 can be placed on the exposed major surface of the nanofiber forest 608 (i.e., the major surface of the nanofiber forest 608 not in contact with the growth substrate 603. Examples of the transfer film 612 include polymer sheets (e.g., silicone, polyethylene, polypropylene) having an adhesive strength to the nanofiber forest that is greater than the adhesive strength between the growth substrate 603 and the nanofiber forest 608, but still capable of being removed from the nanofiber forest. In some examples, the adhesive strength between the nanofiber forest 608 and the growth substrate 603 is on the order of from 0.1 N/25 mm to 0.5 N/25 mm. In some examples, the adhesive strength between the nanofiber forest 608 and the transfer film 612 is on the order of from 2 N/25 mm to 4 N/25 mm. The adhesive strength associated with the transfer film 612 can be accomplished using a traditional adhesive (e.g., formed from polymer or oligomers having butyl groups, acrylate groups, among others), or a “mechanical” adhesive that forms a releasable physical connection with the portions of the nanofibers disposed at the exposed surface of the nanofiber forest 608. Examples of the “mechanical” adhesives include, but are not limited to, silicone rubber and solid-phase (i.e., not in a liquid state) paraffin wax. When placed in contact with an exposed major surface of the nanofiber, both of these materials will form a releasable connection with the nanofibers of the nanofiber forest. In the case of a transfer film 612 that is composed of silicone rubber, the transfer film 612 can be stretched (as little as from 1% to 5% elongation) before being applied to the nanofiber forest. The stretch is then released, which can then improve the “grip” of the silicone rubber on the nanofibers. In another case, the transfer film can be coated with a layer of paraffin wax. Some of the exposed portions of nanofibers can then be embedded in the paraffin wax layer to establish releasable mechanical connections. It will be appreciated that these are illustrative examples and that other compositions and mechanisms of adhesion are possible to achieve the desired relative strengths indicated above.

FIG. 6C illustrates a third stack 616 in which the growth substrate 603 has been removed, leaving the nanofiber forest 608 and the transfer film 612. The newly exposed major surface 618 of the nanofiber forest 608 is then placed in contact with a nanofiber film 624, such as a “filtered film” described above and depicted in FIG. 5. This first assembly 620 is depicted in FIG. 6D. As described below in more detail, the nanofiber film 624 can improve adhesion between the nanofiber forest 608 and a final substrate.

However, during transportation, shipment, packaging, or other preparatory steps that may occur before application to a final substrate, the exposed major surface 626 of the nanofiber film 624 may become contaminated.

To prevent contamination of this exposed major surface, and thus preserve its adhesive properties, FIG. 6E depicts an optional technique by which the exposed major surface 626 can be protected. As shown, a second assembly 622 can be prepared and placed in temporary contact with the exposed major surface 626 of the nanofiber film 624 of the first assembly 620. The second assembly 622 includes a support film 632 and a nanofiber film 628 with a coating 630.

The support film 632 of the second assembly 622 can be any type of substrate that adheres to the coating 630 of the nanofiber film. Examples of the support film 632 include, but are not limited to, polymer films (e.g., polyethylene, polypropylene, polyethylene terephthalate, polyamide) that may optionally be coated with an adhesive layer. The adhesive strength between the coating 630 and the support film 632 is configured to be greater than the adhesive strength between the coating 630 and the nanofiber film 624. This ensures that the assembly 622 can be removed from the nanofiber film 624 when desired. Example values of adhesive strength can be greater than 4 N/25 mm.

The nanofiber film 628 can include any of the nanofiber structures described above, including a drawn nanofiber sheet (e.g., as depicted in FIGS. 3 and 4 and described above) and a filtered nanofiber film (e.g., as depicted in FIG. 5 and described above).

The coating 630 formed on the nanofiber film 628 is provided to reduce the adhesion that would normally be present between the nanofiber film 624 and the nanofiber film 628. Examples of the coating 630 include metals such as vanadium, titanium, tungsten, alloys thereof, oxides thereof, and combinations thereof In other examples, the coating 630 can comprise metals or compounds that can form carbide compounds with the carbon nanotubes, thus improving the continuity and adhesion of the coating 630 over the carbon nanotubes. For example, silicon, which can form silicon carbide, can be deposited on the nanofiber film 628. Under the favorable processing conditions (e.g., an oxygen free atmosphere and a high temperature), the silicon can form a coating 630 of silicon carbide. The coating 630 may deposited by, for example sputtering, physical vapor deposition, chemical vapor deposition, among other techniques that will be appreciated in light of this disclosure.

While the coating 630 is shown at coating both major surfaces and the side (minor) surfaces of the nanofiber film 628, it will be appreciated that this not need be the case. In other embodiments, the coating 630 may be on the major surface to be placed in contact with the nanofiber film 624 alone or in combination with any of the other surfaces of the nanofiber film 628.

As indicated by the arrows in FIG. 6E, the assemblies 620 and 622 can be placed together so that the nanofiber film 624 and the coating 630 on the nanofiber film 628 are in contact. This contact between the assemblies 620 and 622 produces super-assembly 634. In some examples, the assemblies 620 and 622 can be applied to one another with pressure (e.g., laminated using one or more rollers, pressed, hot pressed). By compressing the assemblies 620 and 622 together, they can form a durable, if releasable, connection that maintains the mechanical unity and integrity of the super-assembly 634 during movement, shipment, and manipulation of the super-assembly 634 in preparation for further processing.

An example assembly 638 is shown in FIG. 6G. The assembly 638 includes the transfer film 612, the nanofiber filtered film 624 and the nanofiber forest 608. As can be seen in this figure, the second assembly 622 has been removed to expose a major surface 642 of the filtered nanofiber film 624 in preparation for placement of the major surface 642 in contact with a final substrate surface. As described above, the exposed major surface of the filtered film 624 shown in FIG. 6G is protected from contamination and/or mechanical perturbation by the second assembly 622 prior to removal of the latter.

FIG. 6H illustrates the assembly 644 in which the transfer film 612 has been removed to expose a major surface 646 of the nanofiber forest 608 and the exposed major surface 642 of the assembly 638 has been attached to a final substrate 650 via the major surface 642 of the filtered film 624. As described above, the filtered film 624 can have an improved adhesion to the final substrate 650 when compared to the nanofiber forest 608. In this way, the assembly 638 can provide the desired benefits of the nanofiber forest 608 (or alternatively a drawn nanofiber sheet) to a final substrate 650 without the risk of unintentional detachment from the final substrate 650 (due to poor adhesion) or contamination (from an organic molecule-based adhesive).

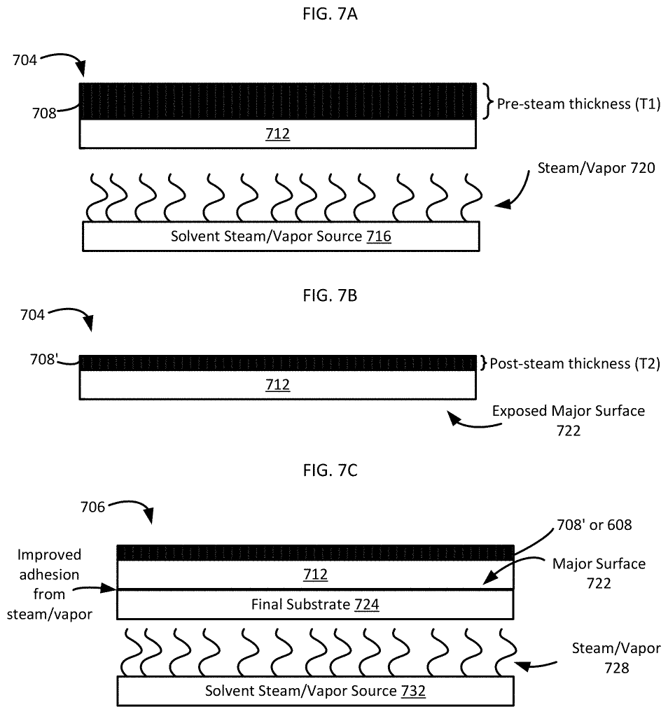

As described below in the context of FIG. 7C, the adhesion at the interface of the major surface 642 and the final substrate 650 surface can be improved upon application of steam or vapor of a solvent.

While the examples described above in the context of FIGS. 6A-6H involve an assembly of a nanofiber filtered film and a nanofiber forest, other combinations of nanofiber structures can be assembled using the techniques described above. FIG. 7A illustrates one such example assembly 704 that includes a drawn nanofiber sheet 708 and a filtered nanofiber film 712.

As shown, the drawn nanofiber sheet 708 and the filtered nanofiber film 712 are in contact with one another at opposing major surfaces. This configuration is analogous to those described above in the context of the first stack 602.

Unlike embodiments configured with a nanofiber forest, however, the nanofiber sheet 708 can be densified, as described above. For example, with continued reference to FIG. 7A, the drawn nanofiber sheet 708 is shown having a pre-steam treatment thickness T1. Values of T1 have been described above in the context of nanofiber sheet thicknesses before densification and can be on the order of to several microns to several hundred microns.

The assembly 704 can be exposed to a steam or vapor 720 from a corresponding steam or vapor source 716. Examples of substances used for the steam or vapor source 716 include organic solvent and inorganic solvents that have been described above in the context of densification of nanofiber sheets. Techniques used to produce steam include heating the solvent source to at or near a boiling point to increase a partial pressure of the solvent in the ambient atmosphere, subjecting the solvent steam/vapor source to ultrasonic agitation (e.g., via an ultrasonic transducer) thus ejecting vapor droplets from the source 716 and onto the nanofiber sheet 708. Other techniques are possible, including spray application of a solvent or immersion of the nanofiber sheet 708 in a solvent.

An example of the result of the densification is illustrated in FIG. 7B, which shows a post-steam thickness T2 of the drawn nanofiber sheet 708′, where T2 is less than T1. Values of T2 after densification of the drawn nanofiber sheet 708′ can be from 10 times to 1000 times thinner.

It will be appreciated that, in some cases, an assembly (analogous to assembly 622) or a filtered nanofiber film (not shown) can be attached to the exposed major surface of the filtered nanofiber film 712 to prevent or reduce exposure of the major surface 722 of the filtered nanofiber film 712 to the solvent steam or vapor 720 while still enabling exposure of the nanofiber sheet 708 to the solvent steam or vapor.

Turning now to FIG. 7C, assembly 706 can be attached to a final substrate 724 via the formerly exposed major surface 722 of the filtered nanofiber film 712. As shown in FIG. 7C, adhesion between the filtered nanofiber film 712 and the final substrate 724 can be improved by exposure to a solvent vapor and/or steam 728. In some cases, upon exposure to the solvent steam or vapor, the adhesion between the final substrate 724 and the nanofiber film 712 becomes fixed (i.e., removal is not possible without damage to the film 712, the nanofiber structure 708′ or 608 (in the case of a forest), the final substrate 724, or all three).

### Further Considerations

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A method comprising:
providing a nanofiber structure having an exposed major surface, the nanofiber structure comprising an array of aligned nanofibers;
providing a filtered nanofiber film having a first major surface and a second major surface;
placing the first major surface of the filtered nanofiber film in contact with the exposed major surface of the nanofiber structure;
placing the second major surface of the filtered nanofiber film in contact with a final substrate; and
responsive to placing the second major surface of the filtered nanofiber film in contact with the final substrate, adhering the nanofiber structure to the final substrate via the filtered nanofiber film.

2. The method of claim 1, wherein the array of aligned nanofibers comprises a nanofiber forest or a drawn nanofiber sheet.

3. The method of claim 2, further comprising densifying the drawn nanofiber sheet by exposing the drawn nanofiber sheet to a solvent vapor or solvent steam.

4. The method of claim 1, further comprising removing a releasable assembly from the second major surface of the filtered nanofiber film prior to placing the second major surface of the filtered nanofiber film on the final substrate.

5. The method of claim 4, wherein the releasable assembly comprises a support film and a nanofiber film coated on at least one surface with a material comprising a carbide-forming metal, the coated surface configured for contact with the second major surface of the filtered nanofiber film.

6. The method of claim 1, further comprising exposing the filtered nanofiber film in contact with the final substrate to one or both of a steam or a vapor of a solvent, the exposing increasing adhesion between the filtered nanofiber film and the final substrate relative to the adhesion prior to the exposing.

7. The method of claim 1, wherein the filtered nanofiber film comprises a plurality of nanofibers randomly oriented relative to one another in a plane of the filtered nanofiber film.

8. The method of claim 1, wherein the adhesion between the nanofiber structure and the final substrate via the filtered nanofiber film is greater than adhesion from direct contact between the nanofiber structure and the final substrate.

9. A nanofiber assembly comprising
a first assembly comprising:
a first film comprising a first polymer;
a first nanofiber film comprising a first plurality of nanofibers randomly oriented relative to one another in a plane of the first nanofiber film, the first nanofiber film having a first major surface and a second major surface;
a nanofiber structure comprising an array of aligned nanofibers between the first film and the first nanofiber film, the nanofiber structure in contact with the first major surface of the first film;
a second assembly comprising:
a second film comprising a second polymer;
a second nanofiber film on the second film, the second nanofiber film comprising a second plurality of nanofibers randomly oriented relative to one another in a plane of the second nanofiber film; and
a coating on at least one major surface of the second nanofiber film, the coating in releasable contact with the second major surface of the first nanofiber film.

10. The nanofiber assembly of claim 9, wherein the array of aligned nanofibers comprises a nanofiber forest or a drawn nanofiber sheet.

11. The nanofiber assembly of claim 9, wherein the coating comprises a carbide-forming metal.

12. The nanofiber assembly of claim 11, wherein the carbide-forming metal includes vanadium, tungsten, titanium, and alloys thereof.

13. The nanofiber assembly of claim 9, wherein the second assembly is removable from the first assembly without damaging the first assembly.

14. An assembly comprising:
a nanofiber structure comprising an array of aligned nanofibers;
a substrate under the nanofiber structure; and
a nanofiber film between the nanofiber structure and the substrate, the nanofiber film comprising a plurality of nanofibers randomly oriented relative to one another in a plane of the nanofiber film, the nanofiber film having a first major surface and a second major surface,
wherein the first major surface of the nanofiber film is in direct contact with a confronting surface of the nanofiber structure and the second major surface of the nanofiber film is in direct contact with a confronting surface of the substrate.

15. The assembly of claim 14, wherein the nanofiber structure of aligned nanofibers comprises a nanofiber forest or a drawn nanofiber sheet.

16. The assembly of claim 15, wherein the drawn nanofiber sheet is a densified drawn nanofiber sheet.

17. The assembly of claim 14, wherein the nanofiber film comprises 80 weight % or less of multiwall carbon nanotubes and 20 weight % or more of one or both of single wall or few wall carbon nanotubes, a total of which is 100 weight %.

18. The assembly of claim 17, wherein:
the multiwall carbon nanotubes have from 4 to 20 concentric walls and a diameter of from 4 nm to 100 nm;
the few wall carbon nanotubes have 2 or 3 concentric walls and a diameter of from 2 nm to 6 nm; and
the single wall carbon nanotubes have a diameter of from 0.2 nm to 4 nm.
